(19) United States
(12) Patent Application Publication
(10) Pub. No.: US 2024/0190571 A1
(43) Pub. Date: Jun. 13, 2024

(54) AIRCRAFT INTERIOR LAVATORY

(71) Applicant: B/E Aerospace, Inc., Winston-Salem, NC (US)

(72) Inventors: Donald F. Cook, Arlington, WA (US); Liberty Harrington, Seattle, WA (US); Philipp Steiner, Seattle, WA (US); Robert K. Brauer, Seattle, WA (US); Trevor Skelly, Mercer Island, WA (US)

(73) Assignee: B/E Aerospace, Inc., Winston-Salem, NC (US)

(21) Appl. No.: 18/390,976

(22) Filed: Dec. 20, 2023

Related U.S. Application Data
(63) Continuation of application No. 17/362,163, filed on Jun. 29, 2021, now Pat. No. 11,873,097.
Application No. 17/362,163 is a continuation of application No. 16/819,878, filed on Mar. 16, 2020, now Pat. No. 11,077,946.
Application No. 16/819,878 is a continuation of application No. 16/283,471, filed on Feb. 22, 2019, now Pat. No. 10,625,862.
Application No. 16/283,471 is a continuation of application No. 15/258,529, filed on Sep. 7, 2016, now Pat. No. 10,259,558.
Application No. 15/258,529 is a continuation of application No. 15/141,494, filed on Apr. 28, 2016, now Pat. No. 9,463,878.
Application No. 15/141,494 is a continuation of application No. 14/709,378, filed on May 11, 2015, now Pat. No. 9,365,292.
Application No. 14/709,378 is a continuation of application No. 14/043,500, filed on Oct. 1, 2013, now Pat. No. 9,073,641.
Application No. 14/043,500 is a continuation of application No. 13/089,063, filed on Apr. 18, 2011, now Pat. No. 8,590,838.
(60) Provisional application No. 61/326,198, filed on Apr. 20, 2010.
(60) Provisional application No. 61/346,835, filed on May 20, 2010.

(51) Int. Cl. B64D 11/02; B64C 1/10; B64D 11/06; B64F 5/00

(52) U.S. Cl. CPC B64D 11/02; B64C 1/10; B64D 11/06; B64D 11/064; B64F 5/00; Y02T 50/40

(57) ABSTRACT

A lavatory for an aircraft cabin includes a wall having a forward wall portion disposed immediately aft of and substantially conforming to an exterior aft surface of an aircraft cabin structure, such as a passenger seat, that is substantially not flat in a vertical plane. The forward wall portion includes a forward projection over an aft portion of the adjacent passenger seat. The forward wall portion can define a secondary space in the interior lavatory space, which can provide an amenity stowage space, and can include design elements providing visual space.

### CROSS-REFERENCE TO RELATED PATENT APPLICATIONS

This application is a Continuation of application Ser. No. 17/362,163, filed Jun. 29, 2021, which is a Continuation of application Ser. No. 16/819,878, filed Mar. 16, 2020, now U.S. Pat. No. 11,077,946, which is a Continuation of application Ser. No. 16/283,471, filed Feb. 22, 2019, now U.S. Pat. No. 10,625,862, which is a Continuation of application Ser. No. 15/258,529, filed Sep. 7, 2016, now U.S. Pat. No. 10,259,558, which is a Continuation of application Ser. No. 15/141,494, filed Apr. 28, 2016, now U.S. Pat. No. 9,463,878, which is a Continuation of application Ser. No. 14/709,378, filed May 11, 2015, now U.S. Pat. No. 9,365,292, which is a Continuation of application Ser. No. 14/043,500, filed Oct. 1, 2013, now U.S. Pat. No. 9,073,641, which is a Continuation of application Ser. No. 13/089,063, filed Apr. 18, 2011, now U.S. Pat. No. 8,590,838, which claims the benefit of Provisional Application No. 61/326,198, filed Apr. 20, 2010, and Provisional Application No. 61/346,835, filed May 20, 2010, all of which are incorporated by reference herein in their entireties.

### BACKGROUND OF THE INVENTION

The present invention relates generally to aircraft enclosures, and more particularly relates to an aircraft cabin enclosure, such as a lavatory, an aircraft closet, or an aircraft galley, for example, including an aircraft cabin structure having an aft portion with a substantially vertically extending exterior aft surface that is substantially not flat in a vertical plane.

Aircraft lavatories, closets and other full height enclosures commonly have forward walls that are flat in a vertical plane. Structures such as passenger seats installed forward of such aircraft lavatories, closets and similar full height enclosures often have shapes that are contoured in the vertical plane. The juxtaposition of these flat walled enclosures and contoured structures renders significant volumes unusable to both the function of the flat walled lavatory or enclosure and the function of the contoured seat or other structure. Additionally, due to the lack of a provision for structural load sharing, conventional aircraft lavatories require a gap between the lavatory enclosures and adjacent structures, resulting in a further inefficiency in the use of space.

Aircraft bulkheads, typically separating passenger cabin areas or classes of passenger service, are in common use, and typically have a contour permitting passengers seated behind the bulkhead to extend their feet modestly under the premium seats immediately forward of the bulkhead. These provide a comfort advantage to passengers seated behind the bulkhead, but provide no increased efficiency in the use of space, in that they do not enable the seats fore and aft of the bulkhead to be placed more closely together. Short, floor-mounted stowage boxes, typically no taller than the bottom cushion of a passenger seat, are often positioned between the flat wall of current lavatories or other enclosures and passenger seats. These provide no improvement to the utility or spatial efficiency of the lavatory or other enclosure. While they do provide some useful stowage for miscellaneous items, they do not provide sufficient additional stowage to provide more space for passenger seating.

It would be desirable to provide an aircraft lavatory or other enclosure that can reduce or eliminate the gaps and volumes of space previously required between lavatory enclosures and adjacent structures to allow an adjacent structure such as passenger seating installed forward of the lavatory or other enclosure to be installed further aft, providing more space forward of the lavatory or enclosure for passenger seating or other features than has been possible in the prior art. Alternatively, the present invention can provide a more spacious lavatory or other enclosure with no need to move adjacent seats or other structures forward.

It would also be desirable to provide an aircraft lavatory or other enclosure with a wall to bear loads from an adjacent passenger seating or other structure, permitting elimination of a required gap between the lavatory or other enclosure and the adjacent passenger seating or other structure, making more space available for other uses. In addition, enabling a lavatory or other enclosure to bear loads from an adjacent structure can reduce the combined weight of the lavatory or other enclosure and the adjacent structure.

It also would be desirable to provide an aircraft lavatory or other enclosure that can reduce or eliminate the gaps and volumes of space previously required between lavatory enclosures and adjacent structures, to allow the installation of an increased number of passenger seats, to increase the value of the aircraft. The present invention meets these and other needs.

### SUMMARY OF THE INVENTION

Briefly, and in general terms, the present invention provides for an enclosure, such as a lavatory, an aircraft closet, or an aircraft galley, for example, for a cabin of an aircraft including a structure having an aft portion with a substantially vertically extending exterior aft surface that is substantially not flat in a vertical plane. The enclosure structure permits a combination of the enclosure with the structure in a manner that permits significant saving of space in the aircraft, which in turn permits more seats to be installed, or more space to be offered per seat, increasing the value of the aircraft.

Accordingly, in one presently preferred aspect, the present invention provides for an enclosure unit for a cabin of an aircraft including an aircraft cabin structure having an aft portion with an exterior aft surface that is substantially not flat in a vertical plane. The enclosure unit can be a lavatory, an aircraft closet, or an aircraft galley, for example. In one presently preferred aspect, the enclosure unit includes one or more walls that are taller than an adjacent aircraft cabin structure, the one or more walls defining an interior enclosure space and having a forward wall portion. The forward wall portion is configured to be disposed immediately aft of and adjacent to or abutting the exterior aft surface of the aircraft cabin structure, and the forward wall portion is shaped to substantially conform to the shape of the exterior aft surface of the aircraft cabin structure.

In another presently preferred aspect, the enclosure unit includes an enclosure stall unit, and the aircraft cabin structure is a passenger seat installed immediately forward of the enclosure stall unit. In another presently preferred aspect, the forward wall portion of the enclosure unit is configured to accept loads from the aircraft passenger seat. In another presently preferred aspect, the forward wall portion includes a forward projection configured to project over an aft portion of the adjacent passenger seat immediately forward of the enclosure stall unit.

In another presently preferred aspect, the enclosure is a lavatory, including a lavatory stall unit with one or more walls having a forward wall portion. The one or more walls define an interior lavatory space, and the forward wall portion is configured to be disposed immediately aft of and adjacent to or abutting an aircraft cabin structure having an exterior aft surface having a shape that is substantially not flat in a vertical plane. In a presently preferred aspect, the forward wall portion is shaped to substantially conform to the shape of the exterior aft surface of the aircraft cabin structure.

In another presently preferred aspect, the aircraft cabin structure is a passenger seat installed immediately forward of the lavatory stall unit, and the forward wall portion of the lavatory stall unit is configured to accept loads from the passenger seat. In another presently preferred aspect, the forward wall portion includes a forward projection configured to project over an aft portion of the adjacent passenger seat immediately forward of the lavatory stall unit. In another presently preferred aspect, the forward wall portion defines a secondary space in the interior lavatory space in an area forward of an aft-most portion of the forward wall portion. The secondary space can provide an amenity stowage space inside the lavatory stall unit in the area forward of an aft-most portion of the forward wall portion, and can include design elements providing visual space inside the lavatory in the area forward of an aft-most portion of the forward wall portion.

In another presently preferred aspect, the present invention provides for an assembly of an aircraft enclosure unit and an aircraft cabin structure for an aircraft cabin, the assembly in combination including an aircraft cabin structure having an exterior aft surface having a shape that is substantially not flat in a vertical plane, and an aircraft enclosure unit including at least one wall having a forward wall portion. The one or more walls define an interior enclosure space, the forward wall portion is disposed immediately aft of and adjacent to the aircraft cabin structure, and the forward wall portion is shaped to substantially conform to the shape of the exterior aft surface of the aircraft cabin structure. In another presently preferred aspect, the aircraft cabin structure is a passenger seat installed immediately forward of the aircraft enclosure unit. In another presently preferred aspect, the forward wall portion is configured to accept loads from the aircraft passenger seat. In another presently preferred aspect, the forward wall portion includes a forward projection configured to project over an aft portion of the adjacent passenger seat immediately forward of the aircraft enclosure unit.

In another presently preferred aspect, the aircraft enclosure unit is a lavatory stall, and the one or more walls define an interior lavatory space. In another presently preferred aspect, the forward wall portion defines a secondary space in the interior lavatory space in an area forward of an aft-most portion of the forward wall portion.

In another presently preferred aspect, the present invention provides for an assembly of an aircraft lavatory unit and an aircraft cabin structure for an aircraft cabin, in which the assembly in combination includes an aircraft cabin structure having an exterior aft surface having a shape that is substantially not flat in a vertical plane, and an aircraft lavatory stall unit including one or more walls having a forward wall portion. In another presently preferred aspect, the one or more walls define an interior lavatory space, the forward wall portion is disposed immediately aft of and adjacent to the aircraft cabin structure, and the forward wall portion is shaped to substantially conform to the shape of the exterior aft surface of the aircraft cabin structure. In another presently preferred aspect, the aircraft cabin structure is a passenger seat installed immediately forward of the aircraft lavatory stall unit, and wherein the forward wall portion of the aircraft lavatory stall unit is configured to accept loads from the passenger seat. In another presently preferred aspect, the forward wall portion includes a forward projection configured to project over an aft portion of the adjacent passenger seat immediately forward of the aircraft lavatory stall unit. In another presently preferred aspect, the forward wall portion defines a secondary space in the interior lavatory space in an area forward of an aft-most portion of the forward wall portion.

These and other aspects and advantages of the invention will become apparent from the following detailed description and the accompanying drawings, which illustrate by way of example the features of the invention.

### BRIEF DESCRIPTION OF THE DRAWINGS

FIG. 1 is a schematic diagram of a prior art installation of a lavatory immediately aft of and adjacent to an aircraft passenger seat.

FIG. 2 is a schematic diagram of an installation of a lavatory according to the present invention immediately aft of and adjacent to or abutting an aircraft cabin passenger seat.

### DETAILED DESCRIPTION OF THE PREFERRED EMBODIMENTS

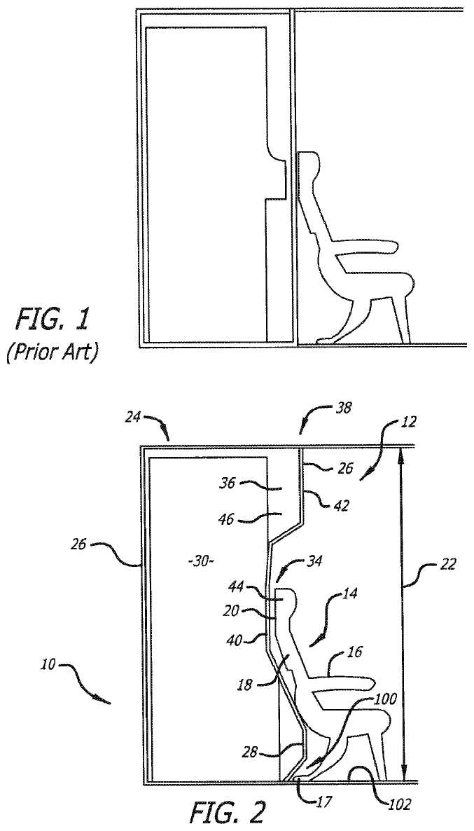

Referring to the drawings, which are provided by way of example, and not by way of limitation, the present invention provides for an enclosure 10, such as a lavatory for a cabin 12 of an aircraft (not shown), although the enclosure may also be an aircraft closet, or an aircraft galley, or similar enclosed or structurally defined spaces, for example. As is illustrated in FIG. 2, the cabin includes a structure 14, and the enclosure may be taller than the cabin structure. The cabin structure can be a passenger seat 16, for example, installed immediately forward of the enclosure and having an aft portion 18 with and exterior aft surface 20 that is substantially not flat in a vertical plane 22. The lavatory includes a lavatory stall unit 24 having one or more walls 26 having a forward wall portion 28. The one or more walls define an interior lavatory space 30, and the forward wall portion is configured to be disposed immediately aft of and adjacent to or abutting the exterior aft surface of the aircraft cabin structure. The forward wall portion has a shape that is substantially not flat in the vertical plane, and preferably is shaped to include a recess 34 such that the forward wall portion substantially conforms to the shape of the exterior aft surface of the aircraft cabin structure. In a presently preferred aspect, the forward wall portion of the lavatory stall unit is configured to accept loads from the passenger seat. As shown in FIG. 2, the forward wall portion 28 can be configured to provide a lower recess 100 formed between the forward wall portion 28 and the cabin deck 102. As also shown in FIG. 2, the lower recess 100 can be configured to receive at least a portion of an aft-extending seat support 17 therein. As can be seen by comparing FIG. 1 and FIG. 2, the recess 34 and the lower recess 100 combine to permit the passenger seat 16 to be positioned farther aft in the cabin than would be possible if the lavatory enclosure 10 included a conventional flat and vertical forward wall without recesses like that shown in FIG. 1, or included a forward wall that did not include both recesses 34, 100.

In another presently preferred aspect, the forward wall portion defines a secondary space 36 in the interior lavatory space in an area 38 forward of an aft-most portion 40 of the forward wall portion, and the forward wall portion includes a forward projection 42 configured to project over the aft portion of the adjacent passenger seat back 44 immediately forward of the lavatory stall unit. The secondary space can include an amenity stowage space 46 inside the lavatory stall unit in the area forward of the aft-most portion of the forward wall portion, and the secondary space can include design elements providing visual space, such as a visual perception of space, inside the lavatory in the area forward of an aft-most portion of the forward wall portion.

It will be apparent from the foregoing that while particular forms of the invention have been illustrated and described, various modifications can be made without departing from the spirit and scope of the invention. Accordingly, it is not intended that the invention be limited, except as by the appended claims.

What is claimed is:

1. A lavatory unit for a cabin of an aircraft, comprising:
an aft wall; and
a forward wall comprising:
an upper portion;
a lower portion;
a middle portion below the upper portion defining an upper recess aftward of at least a portion of the lower portion;
wherein the upper recess is adapted to receive at least a portion of the exterior aft surface of a seat back of a seat immediately forward of the forward wall;
wherein the lower portion of the forward wall is adapted to receive at least a portion of a seat support of the seat aftward of at least a portion of the lower portion for mounting the seat support to the aircraft; and
wherein the forward wall is adapted to receive loads.

2. The lavatory unit of claim 1, wherein the forward wall is adapted to receive loads from the seat.

3. The lavatory unit of claim 1, wherein the forward wall is adapted to receive loads from an adjacent structure exterior of the lavatory unit.

4. The lavatory unit of claim 1, wherein the forward surface of the forward wall is shaped to substantially conform to the shape of the upwardly and aftwardly inclined seat back of the seat.

5. The lavatory unit of claim 4, wherein an aft-facing surface of the lower portion is accessible from the interior.

6. The lavatory unit of claim 4, wherein an aft-facing surface of the middle portion is accessible from the interior.

7. The lavatory unit of claim 4, wherein at least an aft-facing surface of the upper portion, an aft-facing surface of the middle portion, and an aft-facing surface of the lower portion of the forward wall are accessible from an interior of the lavatory unit.

8. The lavatory unit of claim 1, wherein the upper recess is adapted to receive at least a portion of the exterior aft surface of the seat back when the seat back is in an upright and not a reclined position.

9. The lavatory unit of claim 1, wherein the aft-facing surface of the upper portion defines an interior secondary space aftward of the aft-facing surface of the upper portion, and wherein the secondary space is accessible from the exterior of the lavatory unit.

10. A lavatory unit for a cabin of an aircraft, comprising:
an aft wall; and
a forward wall comprising:
an upper portion;
a lower portion;
a middle portion below the upper portion defining an upper recess aftward of at least a portion of the lower portion;
wherein the upper recess is adapted to receive at least a portion of the exterior aft surface of a seat back of a seat immediately forward of the forward wall;
wherein the lower portion of the forward wall is adapted to receive at least a portion of a seat support of the seat aftward of at least a portion of the lower portion for mounting the seat support to the aircraft; and
wherein the forward wall is configured to be positioned adjacent a structure within the cabin without a gap and accept loads from the structure.

11. The lavatory unit of claim 10, wherein the structure comprises the seat.

12. The lavatory unit of claim 10, wherein the structure is exterior of the lavatory unit.

13. A lavatory for a cabin of an aircraft, the cabin having an aircraft passenger seat positioned forward of and adjacent to the lavatory, the lavatory comprising:
an aft wall; and
a forward wall, wherein an interior of the lavatory is disposed between the aft wall and the forward wall, the forward wall comprising:
an upper portion;
a middle portion defining an aft-extending upper recess below the upper portion, the middle portion including a flat portion;
a lower portion below the middle portion;
wherein the lower portion comprises a downward extending vertical portion, and
wherein a seat support of the aircraft passenger seat is secured aft of the downward extending vertical portion, the seat support configured to interface with a floor of the cabin and hold a seat bottom of the aircraft passenger seat in an elevated position.

14. The lavatory of claim 13, wherein the flat portion of the middle portion defines an aft-most portion of the upper recess and the portion of the exterior aft surface of the seat back is an upper seat back such that the aft-most portion of the upper recess is parallel to an aft surface of the upper seat back when the seat back is in the unreclined position.

15. The lavatory of claim 13, wherein the forward wall is configured to accept loads from a structure adjacent the lavatory.

16. The lavatory of claim 15, wherein the lavatory is configured to be positioned adjacent a portion of the structure with no gap.

17. The lavatory of claim 15, wherein the structure comprises the aircraft passenger seat.
